(19) United States
(12) Patent Application Publication
(10) Pub. No.: US 2018/0286321 A1
(43) Pub. Date: Oct. 4, 2018

(54) BACKLIGHT ASSEMBLY, DISPLAY DEVICE, AND ANTI-PHOTOGRAPHED SYSTEM AND METHOD

(71) Applicant: BOE TECHNOLOGY GROUP CO., LTD., Beijing (CN)

(72) Inventors: Jian Gao, Beijing (CN); Xinguo Li, Beijing (CN); Yingyi Li, Beijing (CN); Kairan Liu, Beijing (CN)

(73) Assignee: BOE TECHNOLOGY GROUP CO., LTD., Beijing (CN)

(21) Appl. No.: 15/565,767

(22) PCT Filed: May 4, 2017
(86) PCT No.: PCT/CN2017/083044

§ 371 Date: Oct. 11, 2017

(30) Foreign Application Priority Data
Jul. 20, 2016 (CN) 201610578663.0

(51) Int. Cl. G09G 3/34

(52) U.S. Cl. CPC G09G 3/3406; H04N 5/23293; G09G 2358/00; G09G 2320/064

(57) ABSTRACT

A backlight assembly, a display device, an anti-photographed system, and an anti-photographed method are provided. The backlight assembly includes a backlight source; and a control circuit, coupled to the backlight source and configured to control at least one part of the backlight source to emit a first modulated light that flickers at a preset frequency that is higher than or equal to a scanning frequency of a shutter of a camera.

### CROSS-REFERENCES TO RELATED APPLICATIONS

This application claims the priority of Chinese Patent Application No. 201610578663.0, filed on Jul. 20, 2016, the entire contents of which are incorporated herein by reference.

### FIELD OF THE DISCLOSURE

The present disclosure generally relates to the field of display technology and, more particularly, relates to a backlight assembly, a display device, an anti-photographed system, and an anti-photographed method.

### BACKGROUND

With the rapid development of the light-emitting diode (LED) lighting technology and the flat panel display technology, various types of flat panel display devices have been widely used.

However, the ubiquitous applications of the display devices may bring many information security problems. For example, some places, including museums, secret laboratories, exhibition halls, etc., often use warning signs such as “photography prohibited,” “do not photograph,” or use artificial monitors to prevent or restrict photographing behaviors. Such actions may play a role as a reminder, but may not effectively prevent the attempts to surreptitious photographing.

Accordingly, the disclosed backlight assembly, display device, anti-photographed system, and anti-photographed method are directed to solve one or more problems set forth above and other problems in the art.

### BRIEF SUMMARY OF THE DISCLOSURE

In accordance with some embodiments of the present disclosure, a backlight assembly, a display device, an anti-photographed system, and an anti-photographed method are provided.

One aspect of present disclosure provides a backlight assembly. The backlight assembly includes a backlight source; and a control circuit, coupled to the backlight source and configured to control at least one part of the backlight source to emit a first modulated light that flickers at a preset frequency that is higher than or equal to a scanning frequency of a shutter of a camera.

Optionally, the control circuit is further configured to control the preset frequency of the first modulated light higher than or equal to a flickering frequency of a display screen.

Optionally, the at least one part of the backlight source controls at least a partial display area on a display screen.

Optionally, the control circuit is further configured to control the at least one part of the backlight source to emit a second modulated light including interference information.

Optionally, the control circuit includes: a driving circuit, coupled to the backlight source; and a modulator, coupled to the driving circuit and configured to output a modulation signal, including the interference information, to the driving circuit. The driving circuit is configured to drive the at least one part of the backlight source according to the modulation signal to generate the second modulated light including the interference information.

Optionally, the scanning frequency of the shutter of the camera is between 48 Hz and 60 Hz; the flickering frequency of the display screen is between 50 Hz and 100 Hz; and the preset frequency is between 5 kHz and 15 kHz.

Optionally, the shutter is a rolling shutter.

Optionally, the backlight source includes a plurality of light-emitting diodes (LEDs), and the at least one part of the backlight source includes one or more LEDs of the plurality of LEDs.

Another aspect of present disclosure provides a display device. The display device includes a backlight assembly including a backlight source and a first control circuit coupled to the backlight source; and a display screen positioned in an emitting direction of the backlight assembly. The first control circuit is configured to control at least a part of the backlight source to emit a first modulated light that flickers at a preset frequency that is higher than or equal to a scanning frequency of a shutter of a camera. An image captured by the camera includes a picture displayed on the display screen and a plurality of light-dark stripes superimposed on the picture, in case the display screen is photographed by the camera including the shutter.

Another aspect of present disclosure provides an anti-photographed system. The anti-photographed system includes the disclosed display device and an external light source outside of the display device. The external light source includes a light emitting device, and a second control circuit configured to control the light emitting device to emit a third modulated light having a flickering frequency of the preset frequency.

Optionally, the second control circuit is further configured to control the light emitting device to emit a fourth modulated light including interference information.

Optionally, in case the display screen is photographed by the camera including the shutter, the image captured by the camera includes the picture displayed on the display screen, a first group of light-dark stripes formed by the backlight assembly superimposed on the picture, and a second group of light-dark stripes formed by the external light source superimposed on the first group of light-dark stripes.

Another aspect of present disclosure provides an anti-photographed method, including: displaying a picture on a display screen; and controlling, by a control circuit, at least one part of a backlight source to emit a first modulated light on the display screen. The first modulated light flickers at a preset frequency higher than or equal to a scanning frequency of a shutter of a camera and higher than or equal to a flickering frequency of the display screen. In case the display screen is photographed by the camera including the shutter, an image captured by the camera includes the picture displayed on the display screen and a group of light-dark stripes formed by the first modulated light superimposed on the picture.

Optionally, the at least one part of the backlight source controls at least a partial display area on the display screen.

Optionally, the backlight source includes a plurality of light-emitting diodes (LEDs), and at least one part of the backlight source includes one or more LEDs of the plurality of LEDs.

Optionally, the method further includes controlling the at least one part of the backlight source to emit a second modulated light including interference information.

Optionally, the method further includes using an external light source outside of the display screen to emit a third modulated light having a flickering frequency of the preset frequency on the display screen.

Optionally, the external light source includes: a light emitting device and another control circuit configured to control the light emitting device.

Optionally, the method further includes controlling the light emitting device to emit a fourth modulated light including interference information on the display screen.

Optionally, in case the display screen is photographed by the camera including the shutter, the image captured by the camera includes the picture displayed on the display screen, the group of light-dark stripes formed by the at least one part of the backlight source superimposed on the picture, and another group of light-dark stripes formed by the external light source superimposed on the group of light-dark stripes.

Other aspects of the present disclosure can be understood by those skilled in the art in light of the description, the claims, and the drawings of the present disclosure.

### BRIEF DESCRIPTION OF THE DRAWINGS

Various objectives, features, and advantages of the present disclosure can be more fully appreciated with reference to the detailed description of the present disclosure when considered in connection with the following drawings, in which like reference numerals identify like elements. It should be noted that the following drawings are merely examples for illustrative purposes according to various disclosed embodiments and are not intended to limit the scope of the present disclosure.

FIG. 1 illustrates a schematic structural diagram of an exemplary backlight assembly in accordance with some embodiments of the present disclosure;

FIG. 2 illustrates a schematic diagram of a scanning process of a rolling shutter.

FIG. 3 illustrates schematic camera shoot diagrams of an exemplary display screen corresponding to a backlight assembly in accordance with some embodiments of the present disclosure;

FIG. 4 illustrates a schematic structural diagram of an exemplary display device in accordance with some embodiments of the present disclosure;

FIG. 5 illustrates a schematic structural diagram of an exemplary anti-photographed system in accordance with some embodiments of the present disclosure;

FIG. 6 illustrates schematic camera shoot diagrams of an exemplary display screen under a modulated light emitted from an external light source in accordance with some embodiments of the present disclosure;

FIG. 7 illustrates schematic light-dark striped images photographed by a camera in accordance with some embodiments of the present disclosure; and

FIG. 8 illustrates a schematic flowchart of an exemplary anti-photographed method in accordance with some embodiments of the present disclosure.

### DETAILED DESCRIPTION

Reference input now be made in detail to exemplary embodiments of the invention, which are illustrated in the accompanying drawings in order to fully understand and being able to implementing the present disclosure and to realizing the technical effect. It should be understood that the following description has been made only by way of example, but not to limit the present disclosure. Various embodiments of the present disclosure and various features in the embodiments that are not conflicted with each other can be combined and rearranged in various ways. Without departing from the spirit and scope of the present disclosure, modifications, equivalents, or improvements to the present disclosure are understandable to those skilled in the art and are intended to be encompassed within the scope of the present disclosure.

In accordance with various embodiments, the present disclosure provides a backlight assembly, a display device, an anti-photographed system, and an anti-photographed method.

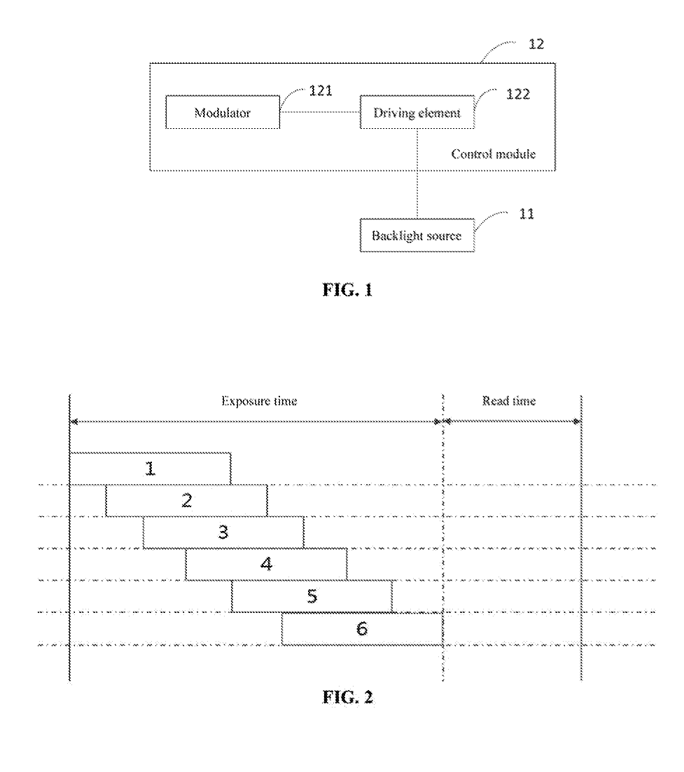

Referring to FIG. 1, a schematic structural diagram of an exemplary backlight assembly is illustrated in accordance with some embodiments of the present disclosure.

As shown, the backlight assembly can include a backlight source 11, and a control circuit 12 connected to the backlight source 11.

The control circuit 12 can be used for controlling, for example, at least a part of the backlight source 11 to emit a modulated light. The modulated light may emit to partially or wholly control a display area of the display screen. The modulated light can be controlled to flicker at a preset frequency which is higher than or equal to a scanning frequency of a camera shutter, and is further higher than a flickering frequency of a display screen.

In the disclosed backlight assembly, the backlight source can be controlled to emit a modulated light which flickers at the preset frequency which is higher than or equal to the scanning frequency of a camera shutter. When a camera including the camera shutter photographs a display screen positioned in the direction of the light exit of the backlight assembly, the image captured by the camera can be a superimposed image of a picture displayed on the display screen and light-dark stripes formed by the modulated light. The light-dark stripes formed by the modulated light can produce a blocking effect on the picture displayed on the display screen. As such, it is impossible for a photographer to clearly or completely obtain a photo of the picture displayed on the display screen. Therefore, the surreptitious photographing can be effectively prevented.

Further, the preset frequency can be larger than the flickering frequency of the display screen, so that the flicker of the backlight source cannot be recognized by human eyes. Thus, the normal display of the display screen is not affected.

In some embodiments, the camera shutter is a rolling shutter.

The shutters in cameras or mobile phones are rolling shutters. Referring to FIG. 2 illustrates a schematic diagram of a scanning process of a rolling shutter.

An image can be captured by a photographic chip in a camera or a mobile phone using a column by column exposing method. As shown in FIG. 2, the numbers are columns scanning successively by the rolling shutter. After a complete scanning of each column, a certain read time is required to read the corresponding image information. The rolling shutter can control sensor by a switch, so that different parts of the sensor can have different sensitivities of light at different times. The exposure can be processed column by column until all pixels are exposed.

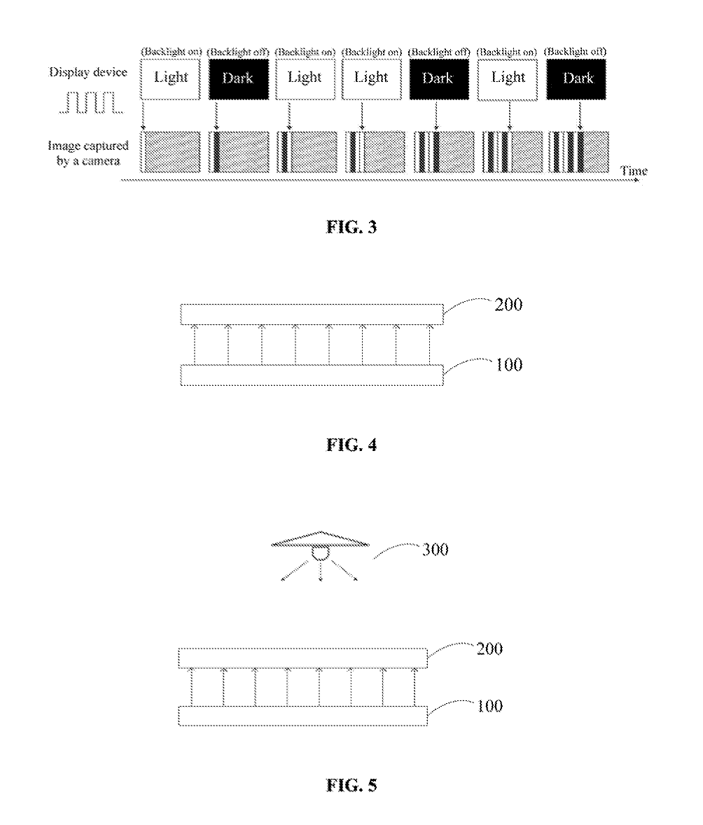

Referring to FIG. 3, schematic camera shoot diagrams of a display screen positioned in the direction of the light exit of a disclosed backlight assembly are illustrated.

In some implementations, the light emitted by the backlight source is a modulated light that flickers according to the preset frequency. As shown in FIG. 3, at a certain time, the driving voltage of the backlight assembly can be a high voltage. That is, when the state of the backlight is “light,” the image obtained by the rolling shutter is a “light column.” At another certain time, the driving voltage of the backlight source can be a low voltage. That is, when the state of the backlight is “dark,” the image obtained by the rolling shutter is a “dark column.”

The light emitted by the backlight source can constantly flicker at the preset frequency. As such, when the camera having the rolling shutter take a photo of the display screen positioned in the direction of the light exit of the backlight assembly, the captured image can have light-dark stripes.

At the boundaries of the light stripes and the dark stripes, the gray values can be in a middle state. The reason is that, due to the working process of the rolling shutter, one exposure time corresponding to the previous high voltage signal may continue to the next scanning.

Still referring to FIG. 1, in some embodiments, in the disclosed backlight assembly, the control circuit 12 can be further used to control the backlight source 11 to emit a modulated light including interference information.

In some specific implementations, the interference information can also be loaded into the modulated light emitted by the backlight, thereby further enhancing the interference to the exposure-read process of the camera. Specifically, the backlight source can be controlled according to a preset rule to flicker. The preset rule can represent specific interference information. When the camera takes a photo of the display screen positioned in the direction of the light exit of the backlight assembly, the interference information can be recognized according to the rule of the light-dark stripes, and an image containing the interference information can be obtained.

For example, the backlight source can be controlled to flicker following an order of “light,” “dark,” “light,” “light,” “dark,” which indicates an interference image containing a sign of “photography prohibited.” As a result, the image captured by the camera can include the sign of “photography prohibited.” In practice, the camera can be an intelligent terminal, such as a smart phone, a tablet, etc., that integrates corresponding identification hardware or software, so that the intelligent terminal can read the corresponding interference information by identifying the light-dark stripes.

Specifically, as shown in FIG. 1, the control circuit 12 can include a driving circuit 122 connected to the backlight source 11, and a modulator 121 connected to the driving circuit 122.

The modulator 121 can be used for outputting a modulation signal including interference information to the driving circuit 122.

The driving circuit 122 can be used for driving the backlight source 11 according to the modulation signal to emit the modulated light which flickers at a preset rule corresponding to the interference information.

The modulation signal including interference information can be outputted from the modulator 121 to the driving circuit 122. And the driving circuit 122 can drive the backlight source 11 to emit the modulated light which flickers at a preset rule corresponding to the interference information.

In some particular implementations, a variety of signal modulation and loading methods can be employed by the modulator 122 to obtain the modulated signal. The variety of signal modulation and loading methods can include pulse position modulation (PPM), on-offkeying (OOK) modulation, pulse width modulation (PWM), etc. The modulation information can be generally outputted to the driving circuit 122 in the form of square waves, sine waves, and/or triangular waves. The driving circuit 122 may control the light source of the backlight source 11 by controlling the driving current or the driving voltage of the backlight source 11 based on the modulation information.

In some specific implementations, in the disclosed backlight assembly, the backlight source can be any suitable light source capable of emitting modulated light that can flicker at the preset frequency, such as a light emitting diode (LED) lamp, a fluorescent lamp, an incandescent lamp, etc.

In some embodiments, the backlight source can be an LED lamp, since it can adapt to the high-frequency switching speed. By changing the driving current or driving voltage of the LED lamp, the LED lamp can flicker at the preset frequency. It should be noted that, the type of the backlight source is not limited. In some other embodiments, the backlight source may be other light source capable of loading a modulation signal, such as an organic light-emitting diode (OLED) lamp, etc.

For example, the backlight source may include a plurality of LEDs. When the backlight source is partially controlled, one or more LEDs of the plurality of LEDs may be controlled to emit light on a partial display area of the display screen.

Specifically, in some embodiments, the scanning frequency of the camera shutter can be larger than 48 Hz and less than 60 Hz, and the flickering frequency of the display screen is larger than 50 Hz and less than 100 Hz.

In some implementations, the exposure time of a rolling shutter can be generally from 1/48 second to 1/60 second. Some smart phones can adjust the exposure time according to demand for more clearly capturing the objects. A general scanning frequency of a rolling shutter can be within 100 Hz. And the flickering frequency of a display screen can be generally from 50 Hz to 100 Hz.

In order to ensure that the rolling shutter can capture the light-dark stripes, the preset frequency can be higher than or equal to the scanning frequency of the rolling shutter. In order to ensure a normal display effect of the display screen, the preset frequency can be larger than the flickering frequency of the display screen. In some embodiments, the preset frequency can be higher than 100 Hz to ensure that the normal display of the display screen is not affected and the camera can capture the light-dark stripes.

In some implementations, the preset frequency can be higher than 5 kHz and less than 15 kHz. For example, the preset frequency can be 8 kHz, 10 kHz or 12 kHz, etc. When the preset frequency is between 5 kHz to 15 kHz, the preset frequency is much larger than the flickering frequency of the display screen and the scanning frequency of the rolling shutter. Since the human eye cannot recognize such fast flickers, the normal display of the display screen is not affected. In addition, the light-dark stripes captured by the camera can have desirable high density, which can further increase the interference effect of modulated light.

Referring to FIG. 4, a schematic structural diagram of a display device is shown in accordance with some embodiments of the present disclosure. As illustrated, the display device can include a disclosed backlight assembly 100, and a display screen 200 positioned in the direction of the light exit of the backlight assembly 100.

The display device can be applied to any suitable apparatus that has a display function, such as a mobile phone, a tablet computer, a television, a monitor, a notebook computer, a digital photo frame, a navigator, and the like. The principle of the display device and the backlight assembly can be referred to the description above in connection with FIGS. 1-3.

In the disclosed display device, the backlight assembly 100 can be controlled to emit a modulated light which flickers at the preset frequency which is higher than or equal to the scanning frequency of a rolling shutter, and is higher than a flickering frequency of the display screen 200 of the display device. When a camera including the rolling shutter photographs the display screen 200, the image captured by the camera can be a superimposed image of a picture displayed on the display screen 200 and light-dark stripes formed by the modulated light superimposed on the picture. The light-dark stripes formed by the modulated light can produce a blocking effect on the picture displayed on the display screen 200. As such, it is impossible for a photographer to clearly or completely obtain a photo of the picture displayed on the display screen 200. Therefore, the surreptitious photographing can be effectively prevented.

In some implementations, the disclosed display device can effectively prevent the displayed information from being surreptitiously photographed, therefore can be used in museums, secret research laboratories, exhibition halls, or other exhibition venues.

Referring to FIG. 5, a schematic structural diagram of an anti-photographed system is shown in accordance with some embodiments of the present disclosure. As illustrated, the anti-photographed system can include a disclosed display device, and an external light source such as an ambient light source 300. The display device can be referred to the description above in connection with FIG. 4.

In the anti-photographed system, the ambient light source 300 can include a light emitting device, and a control circuit connected to the light emitting device.

The control circuit can be used for controlling the light emitting device to emit a modulated light that flickers at a flickering frequency higher than or equal to a scanning frequency of a rolling shutter.

In the ambient light source 300, the control circuit can control the light emitting device to emit a modulated light having a flickering frequency which is higher than or equal to the scanning frequency of a rolling shutter. When a camera including the rolling shutter photographs a display screen of the display device under the modulated light, the image captured by the camera can be a superimposed image formed by a picture displayed on the display screen and the superimposed light-dark stripes formed by: the modulated light from the backlight assembly of the display device and the ambient light source 300.

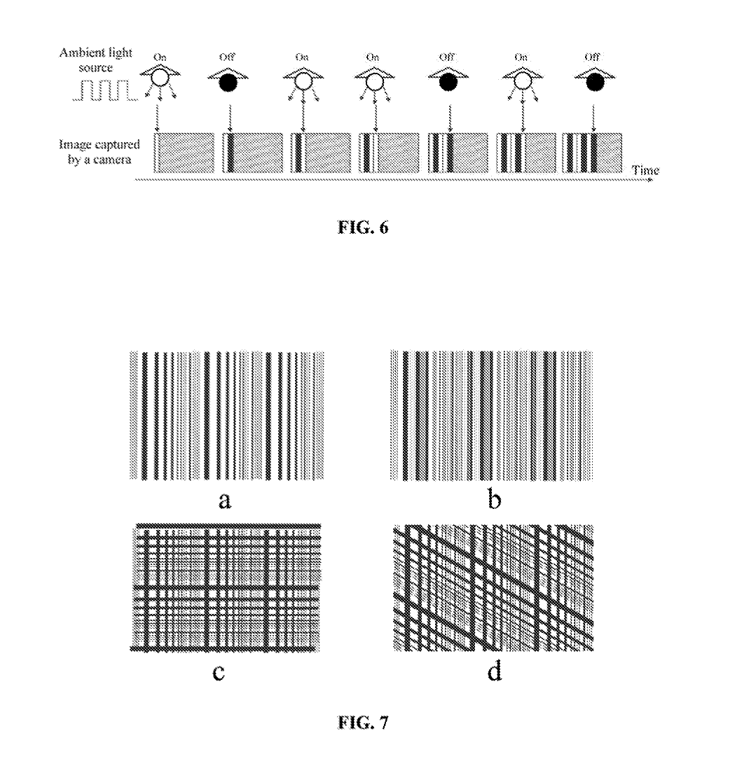

Referring to FIG. 6, schematic camera shoot diagrams of a display screen under the modulated light emitted from the ambient light source 300 are illustrated. The light-dark stripes formed by the modulated light can produce a blocking effect on the picture displayed on the display screen. As such, it is impossible for a photographer to clearly or completely obtain a photo of the picture displayed on the display screen. Therefore, the surreptitious photographing can be effectively prevented.

Since the flickering frequency of the ambient light source 300 is high, human eyes cannot perceive the light changes in such flickering frequency. Therefore, the flickering frequency does not affect the normal lighting of the ambient light source 300.

Further, in some embodiments of the anti-photographed system, the control circuit can be further used to control the light emitting device to emit a modulated light including interference information.

In particular implementations, the interference information can be loaded into the modulated light emitted by the ambient light source 300 to further enhance the interference to the exposure-read process of a camera.

In some embodiments, in the anti-photographed system, the locations of the display device and the ambient light source 300 are different. As such, when a camera having a rolling shutter photographs the display screen of the display device, the light-dark stripes formed by the modulated light emitted from the backlight source and the modulated light emitted from the ambient light source can be superimposed, which further enhances the interference to the image captured by the camera.

Referring to FIG. 7, schematic light-dark striped images photographed by a camera are illustrated.

When the preset frequency of the backlight is equal the flickering frequency of the ambient light source, the light-dark stripes formed by the backlight and the ambient light source can be coincided, as shown in FIG. 7a. When he preset frequency of the backlight is equal the flickering frequency of the ambient light source, the light-dark stripes formed by the backlight and the ambient light source can be the superposed, as shown in FIG. 7b. In some specific implementations, the preset frequency of the backlight and flickering frequency the ambient light source can be same considering the final effect.

In addition, when the camera is a dual-camera mobile phone, the two cameras scanning direction can be different. As such, there may be two groups of light-dark stripes crossing from each other on the image captured by the dual-camera mobile phone, as shown in FIGS. 7c and 7d.

In all above described cases, the original image displayed on the display device can be blocked by the light-dark stripes. As such, it is impossible for a photographer to clearly or completely obtain a photo of the picture displayed on the display screen. Therefore, the surreptitious photographing can be effectively prevented.

Similar to the modulation principle of the backlight, the ambient light source can also be modulated by using a modulation signal to control the driving voltage or driving current of the light source. As such, the flickering frequency of the modulated light emitted from the ambient light source can be higher than or equal to the scanning frequency of the rolling shutter.

In some specific implementations, the ambient light source can be any suitable light source capable of emitting modulated light at the flickering frequency, such as a light emitting diode (LED) lamp, a fluorescent lamp, an incandescent lamp, etc.

In some embodiments, the ambient light source can be an LED lamp. In some other embodiments, the ambient light source may be other light source capable of loading a modulation signal, such as an organic light-emitting diode (OLED) lamp, etc. The type of the ambient light source is not limited. Specifically, the flickering frequency of the ambient light source is larger than 100 Hz.

In some implementations, the flickering frequency of the ambient light source can be higher than 5 kHz and less than 15 kHz, which is much larger than the flickering frequency of the display screen and the scanning frequency of the rolling shutter. Since the human eye cannot recognize such fast flickers, the normal display of the display screen is not affected. In addition, the light-dark stripes captured by the camera can have desirable high density, which can further increase the interference effect of modulated light.

Accordingly, a backlight assembly, a display device, and an anti-photographed system are provided. The backlight assembly can include a backlight, and a control circuit connected to the backlight. The control circuit can be used for controlling the backlight source to emit a modulated light. The modulated light can flicker at a preset frequency which is higher than or equal to a scanning frequency of a camera shutter, and is higher than a flickering frequency of a display screen.

When a camera including the camera shutter photographs the display screen positioned in the direction of the light exit of the backlight assembly, the image captured by the camera can be a superimposed image of a picture displayed on the display screen and light-dark stripes formed by the modulated light superimposed with one on another. The light-dark stripes formed by the modulated light can produce a blocking effect on the picture displayed on the display screen. As such, it is impossible for a photographer to clearly or completely obtain a photo of the picture displayed on the display screen. Therefore, the surreptitious photographing can be effectively prevented.

The disclosed display device includes the above described backlight assembly, and the display screen positioned in the direction of the light exit of the backlight assembly. The disclosed anti-photographed system includes the disclosed display device, and an ambient light source. The ambient light source can also emit a modulated light. When a camera having a rolling shutter photographs the display screen of the display device, the light-dark stripes formed by the modulated light emitted from the backlight source and the modulated light emitted from the ambient light source can be superimposed, which further enhances the interference to the image captured by the camera.

In some other embodiments, the anti-photographed system can include a conventional display device, and the ambient light source that can emit the modulated light. Based on the above described principles, the disclosed anti-photographed system and the disclosed display device can effectively prevent surreptitious photographing.

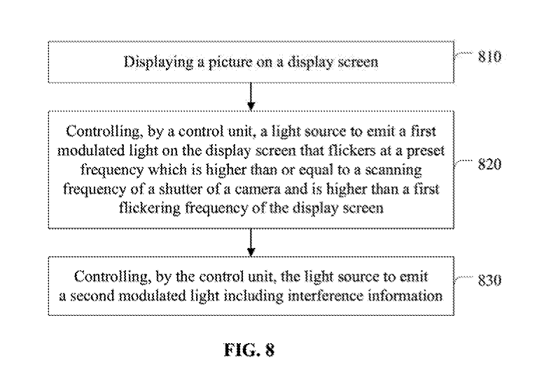

Further, another aspect of the present disclosure provides an anti-photographed method. Referring to FIG. 8, a schematic flowchart of an exemplary anti-photographed method is shown in accordance with some embodiments of the present disclosure.

As illustrated, at 810, a picture can be displayed on a display screen. It should be noted that, the picture can be any suitable image that can be displayed on a display screen, including a frame in a video.

At 820, a light source can be controlled by a control circuit to emit a first modulated light on the display screen that flickers at a preset frequency which is higher than or equal to a scanning frequency of a shutter of a camera and is higher than a first flickering frequency of the display screen, such that when the display screen is photographed by the camera including the shutter, an image captured by the camera is a superimposed image of the picture displayed on the display screen and a group of light-dark stripes formed by the light source superimposed with one on another.

In some embodiments, the light source can be a backlight source of the display screen. In some alternative embodiments, the light source can be an external light source of the display screen. In some other embodiments, the light source can include both a backlight source of the display screen and an external light source of the display screen.

It should be noted that, the scanning frequency of the shutter of the camera can be generally between 48 Hz and 60 Hz, and the flickering frequency of the display screen can be generally between 50 Hz and 100 Hz. In some embodiments, the flickering frequency can be set in a range between 5 kHz and 15 kHz.

At 830, the light source can be controlled by a control circuit to emit a second modulated light including interference information. In interference information can include any suitable information that can be superimposed or represented on the image captured by the camera. That is, when the display screen is photographed by the camera including the shutter, the image captured by the camera may be a superimposed image where the picture displayed on the display screen, a group of light-dark stripes formed by the light source, and the interference information are superimposed with one on another. For example, the superimposed image may be displayed to include: the picture displayed on the display screen, the group of light-dark stripes superimposed on the picture displayed on the display screen, and/or the interference information superimposed on the group of light-dark stripes.

It should be noted that the above steps of the flow diagram of FIG. 8 can be executed or performed in any order or sequence not limited to the order and sequence shown and described in the figure. Also, some of the above steps of the flow diagram of FIG. 8 can be executed or performed substantially simultaneously where appropriate or in parallel to reduce latency and processing times. Furthermore, it should be noted that FIG. 8 is provided as an example only. At least some of the steps shown in the figure may be performed in a different order than represented, performed concurrently, or altogether omitted.

The provision of the examples described herein (as well as clauses phrased as “such as,” “e.g.,” “including,” and the like) should not be interpreted as limiting the claimed subject matter to the specific examples; rather, the examples are intended to illustrate only some of many possible aspects.

Although the present disclosure has been described and illustrated in the foregoing illustrative embodiments, it is understood that the present disclosure has been made only by way of example, and that numerous changes in the details of embodiment of the present disclosure can be made without departing from the spirit and scope of the present disclosure, which is only limited by the claims which follow. Features of the disclosed embodiments can be combined and rearranged in various ways. Without departing from the spirit and scope of the present disclosure, modifications, equivalents, or improvements to the present disclosure are understandable to those skilled in the art and are intended to be encompassed within the scope of the present disclosure.

1. A backlight assembly, comprising:
a backlight source; and
a control circuit, coupled to the backlight source and configured to control at least one part of the backlight source to emit a first modulated light that flickers at a preset frequency that is higher than or equal to a scanning frequency of a shutter of a camera.

2. The backlight assembly of claim 1, wherein:
the control circuit is further configured to control the preset frequency of the first modulated light higher than or equal to a flickering frequency of a display screen.

3. The backlight assembly of claim 1, wherein:
the at least one part of the backlight source controls at least a partial display area on a display screen.

4. The backlight assembly of claim 1, wherein:
the control circuit is further configured to control the at least one part of the backlight source to emit a second modulated light including interference information.

5. The backlight assembly of claim 4, wherein the control circuit includes:
a driving circuit, coupled to the backlight source; and
a modulator, coupled to the driving circuit and configured to output a modulation signal, including the interference information, to the driving circuit,
wherein the driving circuit is configured to drive the at least one part of the backlight source according to the modulation signal to generate the second modulated light including the interference information.

6. The backlight assembly of claim 1, wherein:
the scanning frequency of the shutter of the camera is between 48 Hz and 60 Hz;
the flickering frequency of the display screen is between 50 Hz and 100 Hz; and
the preset frequency is between 5 kHz and 15 kHz.

7. The backlight assembly of claim 1, wherein:
the shutter is a rolling shutter.

8. The backlight assembly of claim 1, wherein:
the backlight source includes a plurality of light-emitting diodes (LEDs), and
the at least one part of the backlight source includes one or more LEDs of the plurality of LEDs.

9. A display device, comprising:
a backlight assembly comprising a backlight source and a first control circuit coupled to the backlight source; and
a display screen positioned in an emitting direction of the backlight assembly;
wherein:
the first control circuit is configured to control at least a part of the backlight source to emit a first modulated light that flickers at a preset frequency that is higher than or equal to a scanning frequency of a shutter of a camera; and
an image captured by the camera includes a picture displayed on the display screen and a plurality of light-dark stripes superimposed on the picture, in case the display screen is photographed by the camera including the shutter.

10. An anti-photographed system, comprising: the display device of claim 9; and an external light source, outside of the display device and including:
a light emitting device, and
a second control circuit configured to control the light emitting device to emit a third modulated light having a flickering frequency of the preset frequency.

11. The anti-photographed system of claim 10, wherein:
the second control circuit is further configured to control the light emitting device to emit a fourth modulated light including interference information.

12. The anti-photographed system of claim 10, wherein:
in case the display screen is photographed by the camera including the shutter, the image captured by the camera includes the picture displayed on the display screen, a first group of light-dark stripes formed by the backlight assembly superimposed on the picture, and a second group of light-dark stripes formed by the external light source superimposed on the first group of light-dark stripes.

13. An anti-photographed method, comprising:
displaying a picture on a display screen; and
controlling, by a control circuit, at least one part of a backlight source to emit a first modulated light on the display screen, wherein:
the first modulated light flickers at a preset frequency higher than or equal to a scanning frequency of a shutter of a camera and higher than or equal to a flickering frequency of the display screen, and
in case the display screen is photographed by the camera including the shutter, an image captured by the camera includes the picture displayed on the display screen and a group of light-dark stripes formed by the first modulated light superimposed on the picture.

14. The anti-photographed method of claim 13, wherein:
the at least one part of the backlight source controls at least a partial display area on the display screen.

15. The anti-photographed method of claim 13, wherein:
the backlight source includes a plurality of light-emitting diodes (LEDs), and
at least one part of the backlight source includes one or more LEDs of the plurality of LEDs.

16. The anti-photographed method of claim 13, further comprising:
controlling the at least one part of the backlight source to emit a second modulated light including interference information.

17. The anti-photographed method of claim 16, further comprising:
using an external light source outside of the display screen to emit a third modulated light having a flickering frequency of the preset frequency on the display screen.

18. The anti-photographed method of claim 17, wherein the external light source includes:
a light emitting device, and
another control circuit configured to control the light emitting device.

19. The anti-photographed method of claim 18, further comprising:
controlling the light emitting device to emit a fourth modulated light including interference information on the display screen.

20. The anti-photographed method of claim 18, wherein:
in case the display screen is photographed by the camera including the shutter, the image captured by the camera includes the picture displayed on the display screen, the group of light-dark stripes formed by the at least one part of the backlight source superimposed on the picture, and another group of light-dark stripes formed by the external light source superimposed on the group of light-dark stripes.
